(19) United States
(12) Patent Application Publication
(10) Pub. No.: US 2009/0224698 A1
(43) Pub. Date: Sep. 10, 2009

(54) VISUAL STAYING DISPLAY AND SCAN METHOD THEREOF

(76) Inventors: Tung-Tsai LIAO, Hsin Chu City (TW); Li Sheng Lo, Hsin Chu County (TW)

Correspondence Address: Muncy, Geissler, Olds & Lowe, PLLC, P.O. BOX 1364, FAIRFAX, VA, 22038-1364, US

(21) Appl. No.: 12/263,651

(22) Filed: Nov. 3, 2008

(30) Foreign Application Priority Data
Mar. 10, 2008 (TW) 097108260

(51) Int. Cl. H05B 37/00

(52) U.S. Cl. 315/321

(57) ABSTRACT

The present invention relates to a visual staying display and a scan method thereof. The method includes the steps of: providing a plurality of first light-emitting diodes (LEDs) and a plurality of second LEDs, wherein the first LEDs and the second LEDs are interlaced arranged in a row; and driving the first LEDs to emit light and determining image data on a corresponding position of the second LEDs according to a variation of terminal voltages of the second LEDs with respect to time in each preset period.

This application claims priority of No. 097108260 filed in Taiwan R.O.C. on Mar. 10, 2008 under 35 USC 119, the entire content of which is hereby incorporated by reference.

### BACKGROUND OF THE INVENTION

1. Field of Invention

The present invention relates to the LED-associated technology, and more particularly to a visual staying display and a scan method thereof.

2. Related Art

Recently, due to the progress of the technology, many consumer electronic products have been sequentially developed. In the early age, a light-emitting diode (LED) light bar is designed according to the visual staying principle. FIG. 1 is a structure diagram showing a conventional LED light bar. Referring to FIG. 1, the circuit includes sixteen LEDs D01 to D16 and a handle 10. FIG. 2 is a schematic illustration showing an internal memory of the conventional LED light bar. As shown in FIG. 2, the LED light bar generally has the internal memory for storing to-be-displayed images. In this memory, each column represents lighting information of the first to sixteenth LEDs D01 to D16 in one period of time, wherein “1” represents that the LED emits light and “0” represents that the LED does not emit light. For example, the first column represents that the first to third LEDs D01 to D03 and the fourteenth to sixteenth LEDs D14 to D16 do not emit light, while the fourth to thirteenth LEDs D04 to D13 emit light in the zeroth to ninth unit periods of times.

FIG. 3 is a schematic illustration showing the displaying of the conventional LED light bar. As shown in FIG. 3, when the user grasps the handle and starts to wave the LED light bar, the LEDs D01 to D16 start to flicker according to the order stored in the memory. Thus, when the LED light bar is being waved, “GO” will be displayed. However, the image displayed by the LED light bar is typically fixed, if the to-be-displayed image is to be updated, the LED light bar has to be connected to a computer inevitably to update the internal memory so that the displayed pattern can be changed. However, the user may feel inconvenient in using the LED light bar.

The prior art has to update the displayed pattern via the computer. Thereafter, Nippon Optical Ltd. has disclosed a scan-type LED light bar. FIG. 4A is a circuit diagram disclosed in China Patent Publication No. N1728197. As shown in FIG. 4A, the circuit mainly utilizes one multiplexer 41 to select one of the LEDs, such as D01, for receiving, and the other multiplexer 42 to select the corresponding LED D02 to make it emit light. When the sensing starts, a capacitor 43 is charged and a node 44 has a ground voltage. FIG. 4B shows operation waveforms in China Patent Publication No. N1728197. As shown in FIG. 4B, the horizontal axis represents the time, and the vertical axis represents a voltage at a node 45. During scanning, the position corresponding to the first LED D01 is black, and the capacitor 43 is discharged via the first LED D01 at the higher rate. Thus, the balance voltage at the node 45 is higher. When the position corresponding to the first LED D01 is white, the capacitor 43 is discharged via the first LED D01 at the lower rate. Thus, the balance voltage at the node 45 is lower.

However, this configuration has to divide the time into a plurality of time sectors according to the order of the LEDs D01 to D16 when scanning each column, and then the corresponding LEDs are respectively selected using the multiplexers 41 and 42 in each corresponding time sector so that the voltage at the node 45 is sensed. Thus, when the LED light bar is scanning and the LED light bar is moved quicker, the sensing tends to fail. In addition, this technique uses two multiplexers 41 and 42, two LED driving circuits and two light detecting circuits. If the quick scan has to be reached, the quicker microprocessor is needed to execute the procedure of progressive scan. In addition, the lighting operations have to be respectively performed according to the order of the LEDs D01 to D16 during displaying. In order to keep the lighting brightness, the required current during displaying is relatively high.

### SUMMARY OF THE INVENTION

It is therefore an objective of the present invention to provide a visual staying display capable of decreasing the design complexity and decreasing the current flowing through the LED.

Another objective of the present invention is to provide a scan method for increasing the scan speed.

To achieve the above-identified or other objectives, the present invention provides a visual staying display having a bar-like casing. The visual staying display includes a rear end portion, a front end portion and a microprocessor. A plurality of first LEDs and a plurality of second LEDs are disposed on the front end portion. The first LEDs and the second LEDs are interlacedly arranged in one row. The microprocessor is coupled to the first LEDs and the second LEDs. When a pattern is being scanned, the microprocessor drives the first LEDs to emit light and determines image data on a corresponding position of the second LEDs according to a variation of terminal voltages of the second LEDs with respect to time in each of preset periods.

The visual staying display according to the preferred embodiment of the present invention further includes a memory for storing the image data, a button for controlling an operation of the display and a wobble sensor for detecting a wobble frequency of the visual staying display.

The present invention provides a scan method. The method includes the steps of: providing a plurality of first LEDs and a plurality of second LEDs, wherein the first LEDs and the second LEDs are interlacedly arranged in one row; and driving the first LEDs to emit light, and determining image data on a corresponding position of the second LEDs according to a variation of terminal voltages of the second LEDs with respect to time in each of preset periods.

In the scan method according to the preferred embodiment of the present invention, the steps of driving the first LEDs to emit light and determining the image data on the corresponding position of the second LEDs according to the variation of the terminal voltages of the second LEDs with respect to time comprise: providing a first common cathode pin coupled to cathodes of the first LEDs; providing a second common cathode pin coupled to cathodes of the second LEDs; providing a plurality of first control pins respectively coupled to anodes of the first LEDs; providing a plurality of second control pins respectively coupled to anodes of the second LEDs; and when a pattern is being scanned: supplying a ground voltage to the first common cathode pin; controlling the first control pins to supply a supply voltage to the anodes of the first LEDs; setting the second common cathode pin to a first predetermined voltage; supplying the ground voltage for the second control pins for the preset period, and then setting the second control pins to a high impedance state; and determining the image data of the second LEDs on the corresponding position according to a time when voltages of the anodes of the second LEDs reach a second predetermined voltage.

In the scan method according to the preferred embodiment of the present invention, the steps of driving the first LEDs to emit light and determining the image data on the corresponding position of the second LEDs according to the variation of the terminal voltages of the second LEDs with respect to time comprise: providing a first common anode pin coupled to anodes of the first LEDs; providing a second common anode pin coupled to anodes of the second LEDs; providing a plurality of first control pins respectively coupled to cathodes of the first LEDs; providing a plurality of second control pins respectively coupled to cathodes of the second LEDs; and when a pattern is being scanned: supplying a supply voltage to the first common anode pin; controlling the first control pins to supply a ground voltage to the cathodes of the first LEDs; setting the second common anode pin to a first predetermined voltage; supplying the supply voltage to the second control pins for the preset period and then setting the second control pins to a high impedance state; and determining the image data of the second LEDs on the corresponding position according to a time when voltages of the cathodes of the second LEDs reach a second predetermined voltage.

The spirit of the present invention is to utilize at least two sets of LEDs interlaced arranged in one row, wherein one set of the LEDs emits light during scanning, and the other set of LEDs scans the image. In addition, as for the LED for detection and its corresponding LED for emitting the light, more than one set of corresponding LEDs can be simultaneously turned on at the same time instant of scanning. Thus, the scan speed is higher than that of the prior art. In the circuit design, it is unnecessary to utilize the multiplexer to select the LEDs, and the system design can be simplified. In addition, the parallel output is adopted, so no additional driving circuit is needed to enhance the brightness. Thus, the cost can be reduced.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a structure diagram showing a conventional LED light bar.

FIG. 2 is a schematic illustration showing an internal memory of the conventional LED light bar.

FIG. 3 is a schematic illustration showing the displaying of the conventional LED light bar.

FIG. 4A is a circuit diagram disclosed in China Patent Publication No. N1728197.

FIG. 4B shows operation waveforms in China Patent Publication No. N1728197.

FIG. 5A is a structure diagram showing a visual staying display according to an embodiment of the present invention.

FIG. 5B is a circuit diagram showing the visual staying display according to the embodiment of the present invention.

FIG. 6 is a flow chart showing a scan method according to the embodiment of the present invention.

FIG. 7 is a schematic illustration showing the scan principle of the LED according to the embodiment of the present invention.

FIG. 8 shows waveforms at an anode of the LED D81 according to the embodiment of the present invention.

FIG. 9 shows the common anode control adopted in the LED of this embodiment different from the embodiment of FIG. 5B.

FIG. 10 is a schematic illustration showing the scan principle of the LED according to the embodiment of the present invention.

FIG. 11 shows waveforms at an anode of the LED D101 according to the embodiment of the present invention.

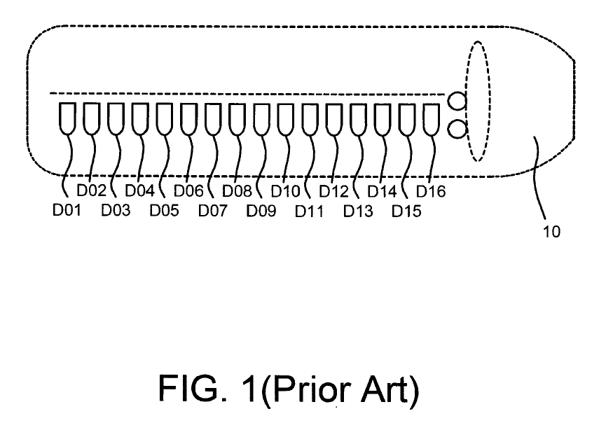

### DETAILED DESCRIPTION OF THE INVENTION

The present invention will be apparent from the following detailed description, which proceeds with reference to the accompanying drawings, wherein the same references relate to the same elements.

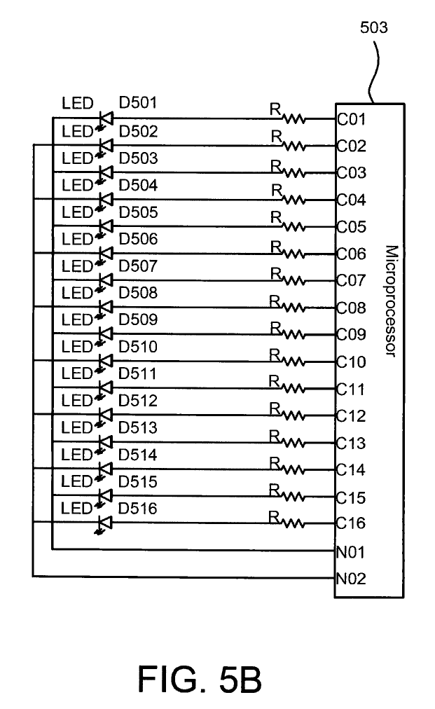

FIG. 5A is a structure diagram showing a visual staying display according to an embodiment of the present invention. FIG. 5B is a circuit diagram showing the visual staying display according to the embodiment of the present invention. Referring to FIG. 5A, the display has a bar-like casing. The display includes a rear end portion 501 and a front end portion 502. The rear end portion is to be handled by the user, for example. A plurality of LEDs D501 to D516 is disposed on the front end portion. Next, as shown in FIG. 5B, the LEDs D501 to D516 are divided into two sets, which are respectively odd-numbered sets of LEDs D501, D503, D505, D507, D509, D511, D513 and D515, and even-numbered sets of LEDs D502, D504, D506, D508, D510, D512, D514 and D516. The cathodes of the odd-numbered sets of LEDs D501, D503, D505, D507, D509, D511, D513 and D515 are coupled to a first common cathode pin N01 of a microprocessor 503, while the cathodes of the even-numbered sets of LEDs D502, D504, D506, D508, D510, D512, D514 and D516 are coupled to a second common cathode pin N02 of the microprocessor 503. The anodes of the LEDs D501 to D516 are coupled to control pins C01 to C16 of the microprocessor 503 via resistors R, respectively. One of ordinary skill in the art should understand that R is a current-limiting resistor, and is not an essential element. So, detailed descriptions thereof will be omitted.

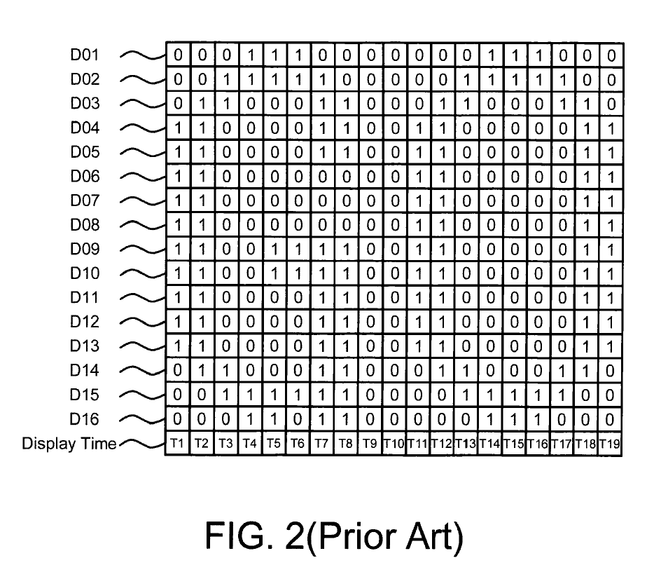

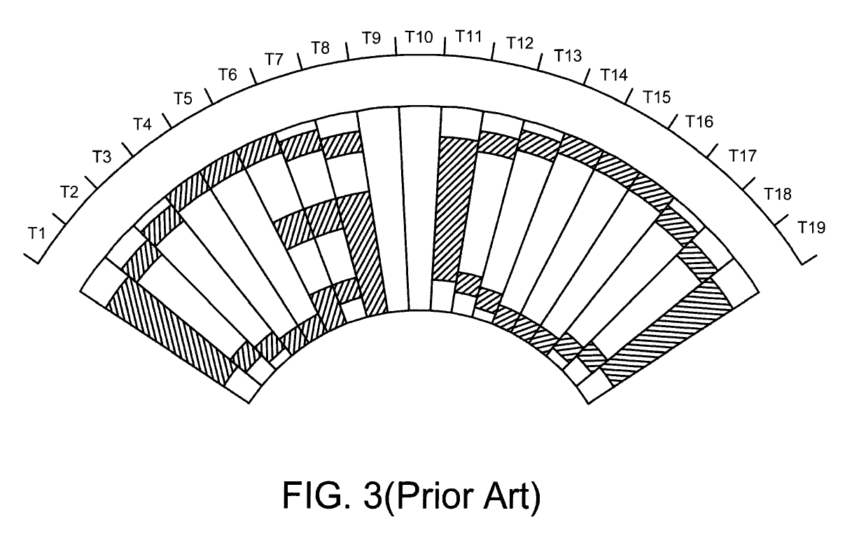

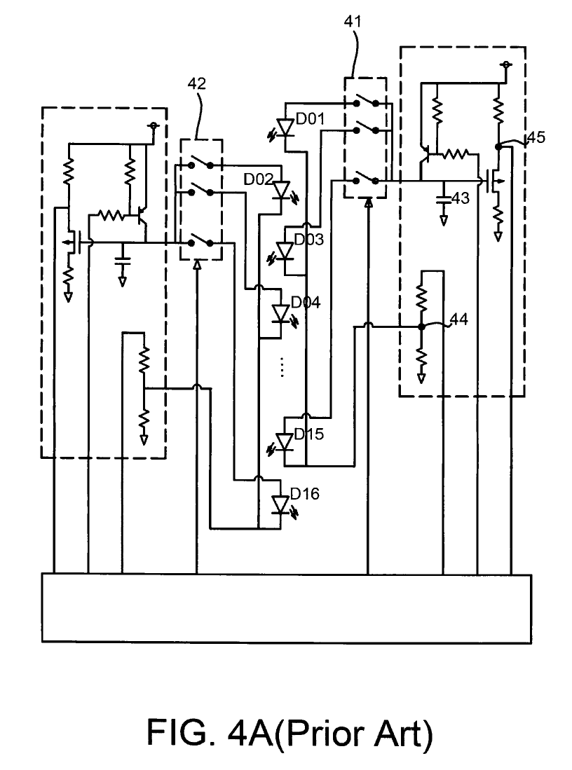

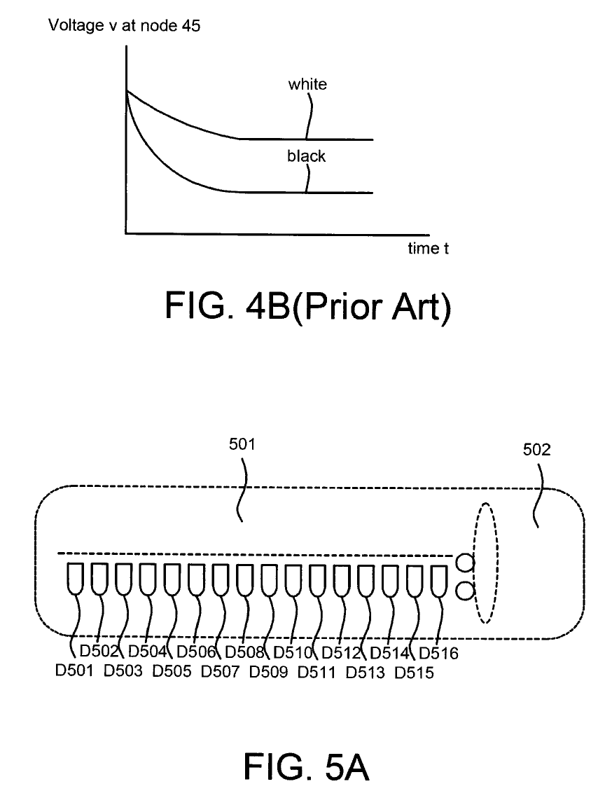

When a pattern is to be displayed, as shown in FIGS. 2 and 3, the corresponding LEDs are simultaneously lighted up in each of preset periods. For example, the fourth to twelfth LEDs D504 to D512 are lighted up at the time instant T1, the third to fourteenth LEDs D503 to D514 are lighted up at the time instant T2, and so on, wherein the detailed descriptions thereof will be omitted.

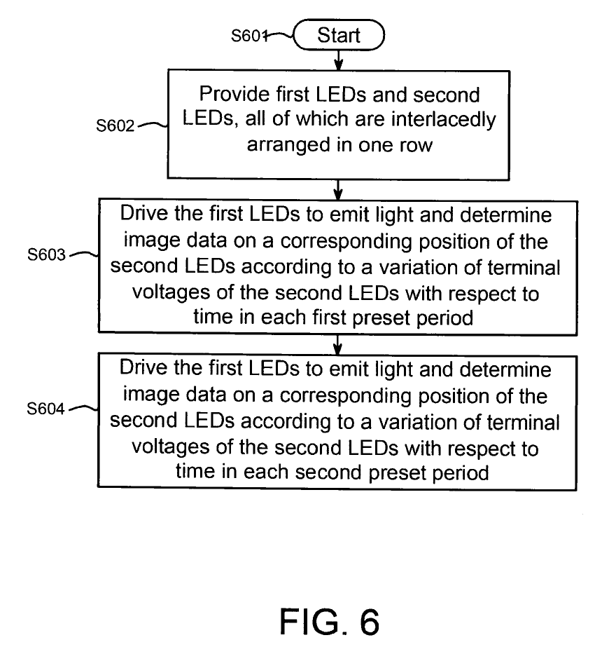

FIG. 6 is a flow chart showing a scan method according to the embodiment of the present invention. Referring to FIGS. 5B and 6, the scan method includes the following steps.

In step S601, the method starts.

In step S602, a plurality of first LEDs and a plurality of second LEDs are provided, wherein the first LEDs and the second LEDs are interlacedly arranged in one row. In FIG. 5B, the LEDs D501 to D516 are divided into the odd-numbered sets of LEDs and the even-numbered sets of LEDs, which are interlacedly arranged.

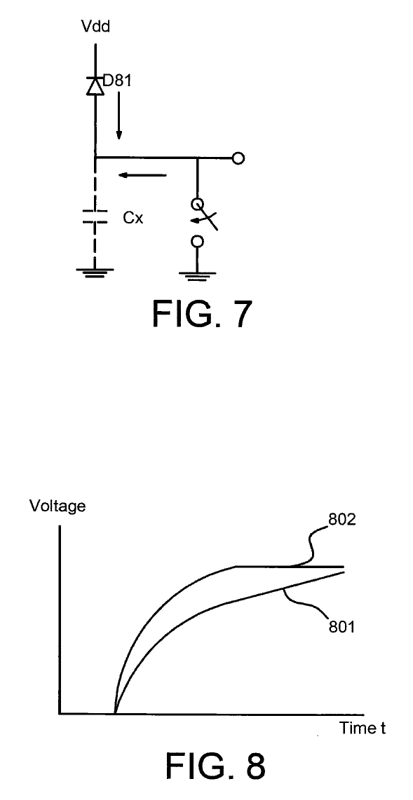

In step S603, in each first preset period, the first LED is driven to emit light, and image data on a corresponding position of the second LEDs is determined according to a variation of terminal voltages of the second LEDs with respect to time. When the user starts to scan the image using the visual staying display, the odd-numbered sets of LEDs D501, D503, D505, D507, D509, D511, D513 and D515 are lighted up. The second common cathode pin N02 is charged to a supply voltage Vdd of an integrated circuit before the scanning starts. FIG. 7 is a schematic illustration showing the scan principle of the LED according to the embodiment of the present invention. FIG. 8 shows waveforms at an anode of the LED D81 according to the embodiment of the present invention. Referring to FIGS. 7 and 8, the LED D81 may be regarded as one of the even-numbered sets of LEDs D502, D504, D506, D508, D510, D512, D514 and D516 in FIG. 5B. When the scanning starts, the cathode of the LED D81 is charged to Vdd, and the anode of the LED D81 is discharged to the ground voltage GND in advance so that it is kept at the high impedance state.

Next, when the LED D81 has scanned the image, the LEDs on two sides thereof emit light to illuminate the to-be-scanned image. The cathode of the LED D81 charges the anode of the LED D81 according to the brightness of the scanned image (i.e., according to the received brightness). When the LED D81 is being manufactured, a stray capacitance Cx is formed. Thus, the voltage at the anode of the LED D81 is increased with time during scanning. Herein, the microprocessor 503 may detect a time when the voltage at the anode of the LED for receiving the image reaches a predetermined voltage via the control pins C01 to C16, or may detect the voltage at the anode of the LED for receiving the image via the control pins C01 to C16 in a certain preset period to determine the brightness of the image.

The waveform 801 corresponds to the voltage at the anode of the LED D81 when the scanned image is brighter; and the waveform 802 corresponds to the voltage at the anode of the LED D81 when the scanned image is darker. That is, when the scanned image is darker, the image absorbs the light generated by the LEDs adjacent to the LED D81 so that the light received by the LED D81 is less. Thus, the current flowing from the cathode of the LED D81 to the anode of the LED D81 is lower, so the voltage rise is slower. Correspondingly, when the scanned image is brighter, the image reflects the light generated by the LED adjacent to the LED D81 so that the light received by the LED D81 is more. The current flowing from the cathode of the LED D81 to the anode of the LED D81 is also higher, so the voltage rise is quicker. Thus, the brightness of the image can be easily judged.

In step S604, in each second preset period, the second LED is driven to emit light, and image data on a corresponding position of the first LEDs is determined according to a variation of terminal voltages of the first LEDs with respect to time. In the second preset period, the even-numbered sets of LEDs D502, D504, D506, D508, D510, D512, D514 and D516 becomes the light source and the odd-numbered sets of LEDs D501, D503, D505, D507, D509, D511, D513 and D515 are for detecting the image. In addition, the first preset period and the second preset period are interlacedly and repeatedly arranged. Therefore, the captured image will become clearer and the resolution of the captured image can be raised. Since the image captured concept in the embodiment of the present invention is described in step S603, so, the detailed descriptions thereof is omitted.

Although one aspect of the present invention is disclosed hereinabove, one of ordinary skill in the art should understand that the target voltage for charging the LED D81 does not have to be the supply voltage Vdd of the integrated circuit after he or she has realized the embodiment of the invention, and that the voltage may be determined according to the design. In addition, a capacitor may also be coupled between the anode of the LED D81 and the ground voltage in addition to the stray capacitance Cx. In addition, the odd-numbered sets of LEDs D501, D503, D505, D507, D509, D511, D513 and D515 are lighted up, and the even-numbered sets of LEDs D502, D504, D506, D508, D510, D512, D514 and D516 are for detecting the image and then the even-numbered sets of LEDs D502, D504, D506, D508, D510, D512, D514 and D516 are lighted up, and the odd-numbered sets of LEDs D501, D503, D505, D507, D509, D511, D513 and D515 are for detecting the image in this embodiment. However, one of ordinary skill in the art should understand that the even-numbered sets of LEDs D502, D504, D506, D508, D510, D512, D514 and D516 are used for the light source, and the odd-numbered sets of LEDs D501, D503, D505, D507, D509, D511, D513 and D515 are only used for detecting the image. Alternatively, the odd-numbered sets of LEDs D501, D503, D505, D507, D509, D511, D513 and D515 are only used for the light source, and the even-numbered sets of LEDs D502, D504, D506, D508, D510, D512, D514 and D516 are only used for detecting the image without departing from spirit of the present invention. So, detailed descriptions thereof will be omitted.

Next, one embodiment will be described to make one of ordinary skill in the art easily understand the spirit of the present invention.

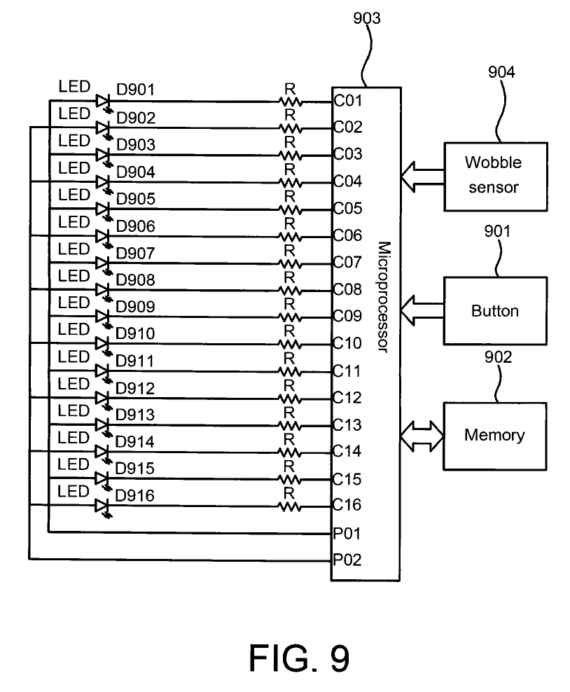

FIG. 9 shows the common anode control adopted in the LED of this embodiment different from the embodiment of FIG. 5B. Referring to FIG. 9, the circuit includes a button 901, a memory 902, a microprocessor 903, LEDs D901 to D916 and a wobble sensor 904. The button may be used to control an operation of the visual staying display to start lighting or entering the scan mode, for example. The memory 902 stores the to-be-displayed image data or the scanned image data. The wobble sensor 904 is mainly adopted to detect the wobble frequency of the visual staying display. The microprocessor 903 may correct the lighting times of the LEDs D901 to D916 according to the wobble frequency detected by the wobble sensor 904.

The difference between the embodiments of FIGS. 9 and 5B is that the LED of this embodiment of FIG. 9 adopts the common anode control. The anodes of the odd-numbered sets of LEDs D901, D903, D905, D907, D909, D911, D913 and D915 are coupled to a first common anode pin P01 of the microprocessor 903, while the anodes of the even-numbered sets of LEDs D902, D904, D906, D908, D910, D912, D914 and D916 are coupled to a second common anode pin P02 of the microprocessor 903.

During scanning, the odd-numbered sets of LEDs D901, D903, D905, D907, D909, D911, D913 and D915 start to emit light, while the anodes of the even-numbered sets of LEDs D902, D904, D906, D908, D910, D912, D914 and D916 are set to the ground voltage. In addition, the cathodes of the even-numbered sets of LEDs D902, D904, D906, D908, D910, D912, D914 and D916 are pre-charged to the supply voltage VDD, and are then set to the high impedance state. After the even-numbered sets of LEDs D902, D904, D906, D908, D910, D912, D914 and D916 receive the light, the cathodes thereof discharge the anode thereof. Thus, as long as the time when the cathodes of the even-numbered sets of LEDs D902, D904, D906, D908, D910, D912, D914 and D916 reach the predetermined voltage is detected, or the voltages at the cathodes of several sets of LEDs D902, D904, D906, D908, D910, D912, D914 and D916 are detected in a predetermined time, the image data on the corresponding position may be obtained.

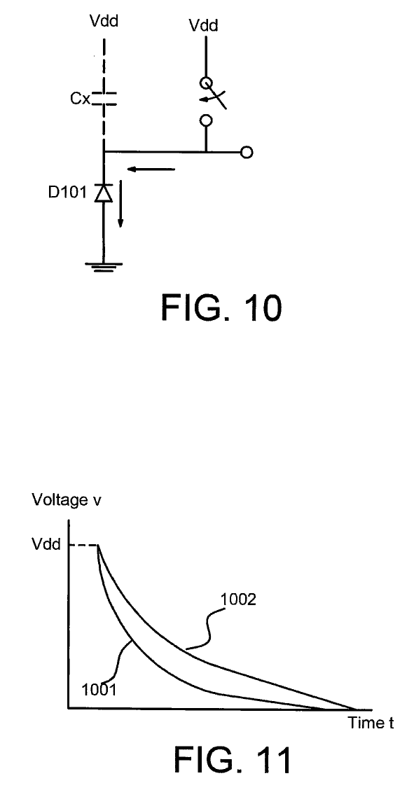

FIG. 10 is a schematic illustration showing the scan principle of the LED according to the embodiment of the present invention. FIG. 11 shows waveforms at an anode of the LED D101 according to the embodiment of the present invention. As shown in FIGS. 10 and 11, the LED D101 may be regarded as any one of the even-numbered sets of LEDs D902, D904, D906, D908, D910, D912, D914 and D916 of FIG. 9. When the scanning starts, the cathode of the LED D101 is discharged to the ground voltage GND, and the anode of the LED D101 is pre-charged to the supply voltage Vdd so that the LED D101 is kept at the high impedance state.

Next, when the LED D101 scans the image, the LEDs on two sides thereof emit light to illuminate the to-be-scanned image. The cathode of the LED D101 charges the anode thereof according to the brightness of the scanned image (i.e., the received brightness). Because the LED D101 has the stray capacitance Cx during the manufacturing process, the voltage of the cathode of the LED D101 is increased with time during scanning. Herein, the microprocessor 903 may detect the time when the voltage at the anode of the LED for receiving the image reaches a predetermined voltage via the control pins C01 to C16, or may detect the voltage at the anode of the LED for receiving the image via the control pins C01 to C16 in a certain preset period to determine the brightness of the image.

The waveform 1001 corresponds to the voltage at the cathode of the LED D101 when the scanned image is brighter; and the waveform 1002 corresponds to the voltage at the cathode of the LED D101 when the scanned image is darker. That is, when the scanned image is darker, the image absorbs the light generated by the LEDs adjacent to the LED D101 so that the light received by the LED D101 is less. Thus, the current flowing from the anode of the LED D101 to the cathode of the LED D101 is also lower, and the voltage drop is slower. Correspondingly, when the scanned image is brighter, the image reflects the light generated by the LEDs adjacent to the LED D101 so that the light received by the LED D101 is more. Thus, the current flowing from the anode of the LED D101 to the cathode of the LED D101 is also higher, so the voltage drop is quicker. Thus, the brightness of the image may be easily judged.

In summary, the spirit of the present invention is to utilize at least two sets of LEDs interlaced arranged in one row, wherein one set of the LEDs emits light during scanning, and the other set of LEDs scans the image. In addition, as for the LED for detection and its corresponding LED for emitting the light, more than one set of corresponding LEDs can be simultaneously turned on at the same time instant of scanning. Thus, the scan speed is higher than that of the prior art. In the circuit design, it is unnecessary to utilize the multiplexer to select the LEDs, and the system design can be simplified. In addition, the parallel output is adopted, so no additional driving circuit is needed to enhance the brightness. Thus, the cost can be reduced.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A visual staying display, comprising:
a bar-like casing, which comprises:
a rear end portion; and
a front end portion, on which a plurality of first light-emitting diodes (LEDs) and a plurality of second LEDs are disposed, wherein the first LEDs and the second LEDs are interlacedly arranged in one row; and
a microprocessor coupled to the first LEDs and the second LEDs, wherein when a pattern is being scanned, the microprocessor drives the first LEDs to emit light and determines image data on a corresponding position of the second LEDs according to a variation of terminal voltages of the second LEDs with respect to time in each of preset periods.

2. The display according to claim 1, further comprising:
a memory for storing the image data.

3. The display according to claim 1, further comprising:
a button for controlling an operation of the display.

4. The display according to claim 1, wherein the microprocessor comprises:
a first common cathode pin coupled to cathodes of the first LEDs;
a second common cathode pin coupled to cathodes of the second LEDs;
a plurality of first control pins respectively coupled to anodes of the first LEDs; and
a plurality of second control pins respectively coupled to anodes of the second LEDs;
wherein when the pattern is being scanned, the microprocessor supplies a ground voltage to the first common cathode pin and controls the first control pins to supply a supply voltage to the anodes of the first LEDs, the microprocessor sets the second common cathode pin to a first predetermined voltage and supplies the ground voltage to the second control pins for the preset period, and sets the second control pins to a high impedance state, and then the microprocessor determines the image data on the corresponding position of the second LEDs according to a time when voltages of the anodes of the second LEDs reach a second predetermined voltage.

5. The display according to claim 1, wherein the microprocessor comprises:
a first common anode pin coupled to anodes of the first LEDs;
a second common anode pin coupled to anodes of the second LEDs;
a plurality of first control pins respectively coupled to cathodes of the first LEDs; and
a plurality of second control pins respectively coupled to cathodes of the second LEDs;
wherein when the pattern is being scanned, the microprocessor supplies a supply voltage to the first common anode pin, and controls the first control pins to supply a ground voltage to the cathodes of the first LEDs, the microprocessor sets the second common anode pin to a first predetermined voltage, supplies the supply voltage to the second control pins for the preset period, and then sets the second control pins to a high impedance state, and then the microprocessor judges the image data on the corresponding position of the second LEDs according to a time when voltages of the cathodes of the second LEDs reach a second predetermined voltage.

6. The display according to claim 1, further comprising:
a wobble sensor for detecting a wobble frequency of the visual staying display.

7. The display according to claim 1, wherein when the pattern is being scanned, the microprocessor drives the second LEDs to emit light, and determines image data on a corresponding position of the first LEDs according to a variation of terminal voltages of the first LEDs with respect to time in each of the preset periods.

8. A scan method, comprising the steps of:
providing a plurality of first LEDs and a plurality of second LEDs, wherein the first LEDs and the second LEDs are interlacedly arranged in one row; and
in each of preset periods:
driving the first LEDs to emit light; and
determining image data on a corresponding position of the second LEDs according to a variation of terminal voltages of the second LEDs with respect to time.

9. The method according to claim 8, wherein the steps of driving the first LEDs to emit the light and determining the image data on the corresponding position of the second LEDs according to the variation of the terminal voltages of the second LEDs with respect to time comprise:
providing a first common cathode pin coupled to cathodes of the first LEDs;
providing a second common cathode pin coupled to cathodes of the second LEDs;
providing a plurality of first control pins respectively coupled to anodes of the first LEDs;
providing a plurality of second control pins respectively coupled to anodes of the second LEDs; and
when a pattern is being scanned:
supplying a ground voltage to the first common cathode pin;
controlling the first control pins to supply a supply voltage to the anodes of the first LEDs;
setting the second common cathode pin to a first predetermined voltage;
supplying the ground voltage for the second control pins for the preset period, and then setting the second control pins to a high impedance state; and
determining the image data on the corresponding position of the second LEDs according to a time when voltages of the anodes of the second LEDs reach a second predetermined voltage.

10. The method according to claim 8, wherein the steps of driving the first LEDs to emit the light and determining the image data on the corresponding position of the second LEDs according to the variation of the terminal voltages of the second LEDs with respect to time comprise:
providing a first common anode pin coupled to anodes of the first LEDs;
providing a second common anode pin coupled to anodes of the second LEDs;
providing a plurality of first control pins respectively coupled to cathodes of the first LEDs;
providing a plurality of second control pins respectively coupled to cathodes of the second LEDs; and
when a pattern is being scanned:
supplying a supply voltage to the first common anode pin;
controlling the first control pins to supply a ground voltage to the cathodes of the first LEDs;
setting the second common anode pin to a first predetermined voltage;
supplying the supply voltage to the second control pins for the preset period and then setting the second control pins to a high impedance state; and
determining the image data of the second LEDs on a corresponding position according to a time when voltages of the cathodes of the second LEDs reach a second predetermined voltage.

11. The method according to claim 8, further comprising, in each of the preset periods, the steps of:
driving the second LEDs to emit light; and
determining image data on a corresponding position of the first LEDs according to a variation of terminal voltages of the first LEDs with respect to time.
